(19) United States
(12) Patent Application Publication
(10) Pub. No.: US 2020/0117722 A1
(43) Pub. Date: Apr. 16, 2020

(54) EFFICIENT FILE STORAGE AND RETRIEVAL SYSTEM, METHOD AND APPARATUS

(71) Applicant: Goke US Research Laboratory, Santa Clara, CA (US)

(72) Inventor: Xinhai Kang, Milpitas, CA (US)

(21) Appl. No.: 16/159,516

(22) Filed: Oct. 12, 2018

(51) Int. Cl. G06F 17/30; G06F 3/06

(52) U.S. Cl. CPC G06F 17/30091; G06F 17/30106; G06F 3/0673; G06F 3/0643; G06F 3/0659; G06F 3/0604

(57) ABSTRACT

A system, method and apparatus for efficiently storing and retrieving files by a host processing system coupled to a mass data storage device. The host processing system issues file storage and retrieval commands that are mapped to a standard or vendor-specific command by storage device drivers in the host processing system. The storage device drivers issue a single file store or file retrieve command, and a file associated with the command is stored on the mass data storage device, or retrieved from the mass data storage device, based on the single standard or vendor-specific command.

### BACKGROUND

### I. Field of Use

The present invention relates to the field of digital data storage and more specifically to efficient storage and retrieval of digital data between a host processing system and a mass data storage device.

### I. Description of the Related Art

Modern computing devices, such as tablet computers, desktop computers, servers, and smart phones, provide a wide variety of useful applications to consumers and businesses alike. These devices often comprise a host processing system for executing computer code stored in a memory, and a mass data storage device coupled to the host processing system via a standard communication bus, for storing relatively large volumes of digital data, such as digital photos, email, documents, etc.

In such devices, a “filesystem” typically resides in the host processing system, and is used to manage and control data storage and retrieval from the mass data storage device. Applications communicate with the filesystem to store or retrieve files from the mass data storage device, and the filesystem converts these requests into commands that access the files in the mass data storage device on a “block” basis, i.e., predefined amounts of digital data. The filesystem performs a number of other tasks as well, such as maintaining data structures to organize file data, including metadata, and storage space management.

Each time a file is stored or retrieved from the data storage system, a large number of read and write commands are issued by the filesystem residing in the host processing system, due to the large number of blocks that must be stored/retrieved in association with the file. These read and write commands must be sent over the communication bus, introducing a delay that degrades system performance. Moreover, mass data storage devices now include widely-disparate storage capabilities and access speed, such as rotational magnetic devices vs. NAND flash devices and, therefore, the filesystem may not be optimized for each type of storage device to achieve maximum storage and retrieval access times.

It would be desirable, therefore, to overcome the limitations of previous file storage and retrieval techniques in order to more efficiently manage data in such computing systems.

### SUMMARY

The embodiments herein describe systems, methods and apparatus for efficiently storing files from a host processing system to a mass data storage device. In one embodiment, a mass data storage device is described, comprising host interface circuitry for receiving commands from a host processing system coupled to the mass data storage device via a communication bus, and for providing previously-stored file data to the host processing system via the communication bus, a memory for storing processor-executable instructions, a mass storage memory for storing files provided by the host processing system and for storing metadata associated with the files, and a storage controller, coupled to the host interface circuitry, the memory, and the mass storage memory, for executing the processor-executable instructions that causes the mass data storage device to receive a single command to store or retrieve an entire file by the host interface circuitry from the host processing system over the communication bus, the command comprising a file identifier, determine an address in the mass storage memory where to locate the file, based on the file identifier and the metadata, and access a memory address in the mass storage memory in accordance with the metadata.

In another embodiment, a method is described for efficient data storage and retrieval, performed by a mass data storage device coupled to a host processing system via a communication bus, comprising receiving a single command to store or retrieve an entire file by the host interface circuitry from the host processing system over the communication bus, the command comprising a file identifier, determining an address in a mass storage memory within the mass data storage device where to find the file, based on the file identifier and the metadata stored by a memory within the mass data storage device, and accessing a memory address, by the filesystem, in the mass storage memory in accordance with the metadata.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 illustrates a conceptual diagram of a prior art storage and retrieval system;

FIG. 2 illustrates a conceptual diagram of one embodiment of a storage and retrieval system in accordance with the teachings herein;

FIG. 3 is a functional block diagram of the host processing system and mass data storage device as shown in FIG. 2;

FIG. 4 is a simplified functional block diagram of one embodiment of the mass data storage device as shown in FIGS. 2 and 3; and

FIGS. 5A and 5B constitute a flow diagram illustrating one embodiment of a method, or algorithm, performed by the storage and retrieval system as shown in FIGS. 2 and 3.

### DETAILED DESCRIPTION

Systems, methods and apparatus are described for efficient data storage and retrieval in modern computing devices and systems. Functions associated with a filesystem, i.e., management and control of a mass data storage device, reside in a mass data storage device coupled to a host processing system via a communication bus. This arrangement results in far fewer commands being sent by the host processing system to store and retrieve data.

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the invention. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The terms “computer-readable medium”, “memory” and “storage medium” includes, but is not limited to, portable or non-portable storage devices, optical storage devices, and various other mediums capable of storing, containing, or carrying instruction(s) and/or data. These terms each may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory. RAM. ROM, flash memory, disk drives, etc. A computer-readable medium or the like may have stored thereon code and/or machine-executable instructions that may represent a procedure, a function, a subprogram, a program, a routine, a subroutine, a module, a software package, a class, or any combination of instructions, data structures, or program statements. A code symbol may be coupled to another code symbol or a hardware circuit by passing and/or receiving information, data, arguments, parameters, or memory contents. Information, arguments, parameters, data. etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code, i.e., “processor-executable code”, or code symbols to perform the necessary tasks (e.g., a computer-program product) may be stored in a computer-readable or machine-readable medium. A processor(s) may perform the necessary tasks.

The embodiments described herein provide specific improvements to a data storage and retrieval system. For example, the embodiments allow the storage and retrieval system to recover data stored in one or more storage mediums in the event of erasures, or errors, due to, for example, media failures or noise, using only XOR arithmetic. Using XOR arithmetic avoids the use of complex arithmetic, such as polynomial calculations rooted in Galois field theory, as is the case with traditional error decoding techniques such as Reed-Solomon. Limiting the calculations to only XOR arithmetic improves the functionality of a data storage and retrieval system, because it allows the use of cheaper, less-powerful processors, and results in faster storage and retrieval than techniques known in the art.

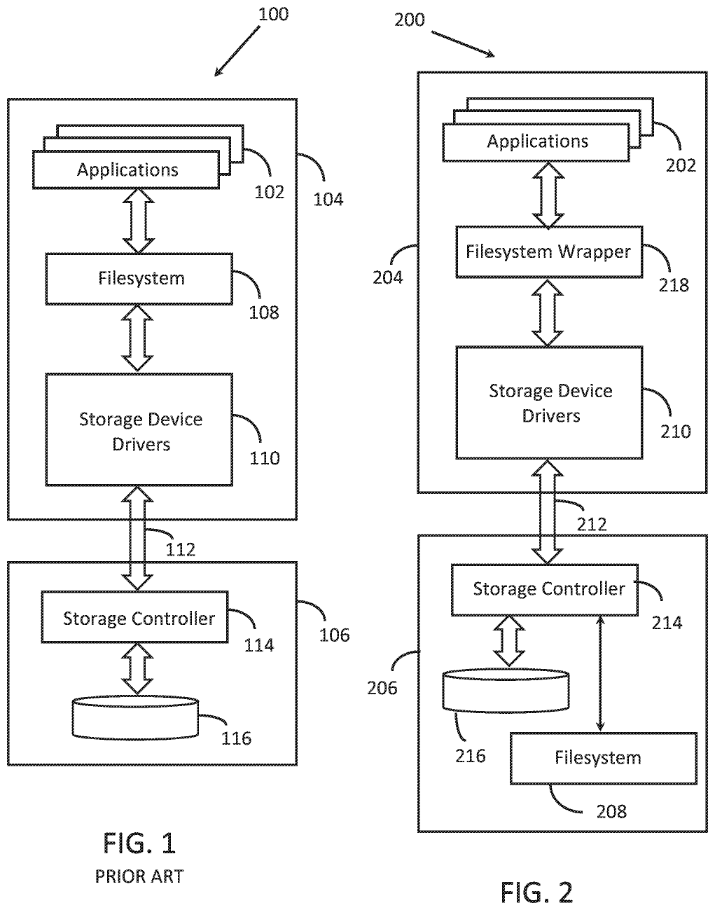

FIG. 1 illustrates a conceptual diagram of a prior art storage and retrieval system 100. One or more software applications 102, such as word processing, web browsing, email, photo editing, crypto-mining, etc., run on host processing system 104. Such applications typically store and retrieve information, in the form of files, to/from a mass storage device, such as a hard drive or SSD, shown as storage device 106.

When a file is stored or retrieved from storage device 106, an application provides a filename to filesystem 108 that identified the file to be stored or retrieved. The filesystem is typically part of the operating system of host processing system 104, and is used to manage the storage space of storage device 106 and creates data structures (including metadata and inode tables) that identify where a file is stored on storage device 106. The filesystem translates file storage and retrieval requests into numerous write and read commands for each file (as well as at least one “open” and “close” command), as each file is typically accessed by the filesystem in predefined data chunks known as “blocks”. For example, if an application sends a command to filesystem 108 to store a particular file, the filesystem refers to an inode table to determine whether the a user of the application is authorized to access the file, the size of the file, the locations (addresses) in storage device 106 wherein the file is stored, and other information. The filesystem then generates a “create” command, which typically comprises a number of read and write operations to storage device 106, followed by a write command for every block of data to be stored. Each of these write commands typically comprises multiple read and write commands.

The commands from the filesystem are passed to storage device driver(s) 110, where they are configured in accordance with a particular communication bus architecture in use by host processing system 104. Examples of such bus architectures include SATA, SATEe, SAS, eMMC, UFS, PCI, PCIe, NVMe, PCI-X, USB, and others. The reconfigured commands are then sent over communication bus 112, which may be part of host processing system 104, to storage controller 114 inside storage device 106. Controller 114 receives the commands from storage device driver(s) 110 and provides access to mass storage memory 116, where controller 114 processes each read and write command to either retrieve or store a block of data, as indicated by the commands from storage device driver(s) 110.

Thus, each time a file is stored or retrieved, filesystem 108 must consult a data structure to determine how the file is, or will be stored, determine various addresses where the file is/will be located, then send multiple commands to storage device 108 in order to store or retrieve one file.

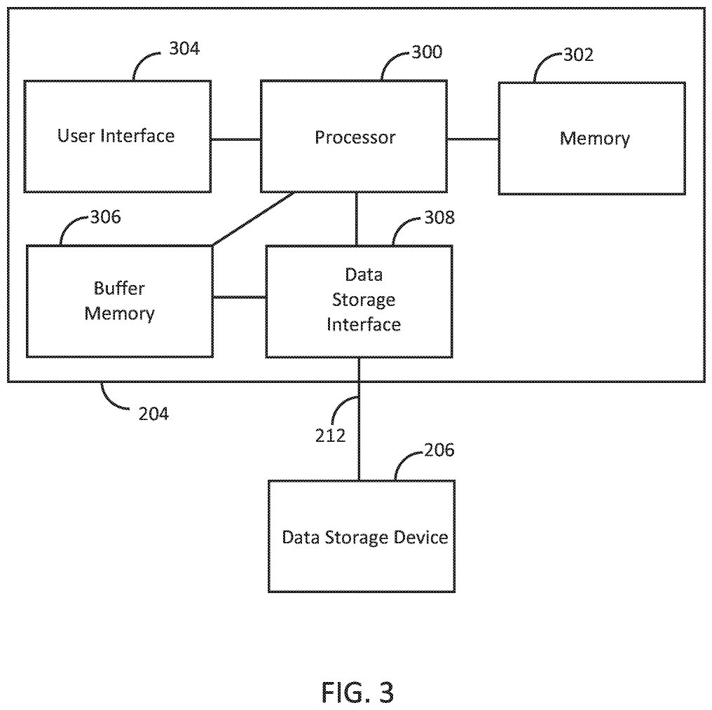

FIG. 2 illustrates a conceptual diagram of one embodiment of a storage and retrieval system 200 in accordance with the teachings herein. In this embodiment, filesystem 108 of FIG. 1 has been moved to storage device 206, shown as filesystem 208, and a new functional component, filesystem wrapper 218, in host processing system 204 has replaced filesystem 108 in host processing system 104. This new data and storage system 200 greatly reduces the number of read and write commands send from host processing system 204 to storage device 206 during file storage or retrieval processes requested by one or more applications 202.

In this embodiment, applications 202 request file storage and retrieval to/from filesystem wrapper 218. Filesystem wrapper 218 simply encapsulates a file identifier, such as a full path file name, and provides it to storage device driver(s) 210. Device driver(s) 210 provides the encapsulated filename as a single request to storage controller 214, where filesystem 208 receives the single request and then processes it to determine how to retrieve a file in the case of a file request, or where and how to store a file, and in one embodiment, associated metadata, in mass storage memory 216 during a storage request. The filesystem produces a series of read and write operations to mass storage memory 216 (or to controller memory 402 or some other memory associated with filesystem 208), based on an operation requested by one of the applications 202. In the case of a file storage command from applications 202, filesystem 208 determines free space in mass storage memory 216 and where the file will be stored on mass storage memory 216.

Although mass data storage device 206 is shown in FIG. 2 as being physically separated from host processing system 204, in other embodiments, mass data storage device 206 is physically part of host processing system 204, i.e., contained within an enclosure with host processing system 204, as in a personal computer. In embodiments where mass data storage device 206 is part of host processing system 204, the communication bus 212 comprises one of a variety of standardized computer buses in compliance with such standards as SATA, SATEe, SAS, eMMC, UFS, PCI, PCIe, NVMe, PCI-X, USB, or others. In these embodiments, mass data storage device 206 typically comprises a connector that plugs into an expansion port on a motherboard of host processing system 204. In embodiments where mass data storage device 206 is physically separated from host processing system 204, communication bus 212 could comprise one or more of an air interface, an Ethernet cable, a SATA cable, a USB cable, a PCIe cable, or other some other cable suitable for the particular storage capabilities of host processing system 204 and mass data storage device 206. In some embodiments, mass data storage device 206 is remotely located from host processing system 204, accessible via one or more wide-area networks, such as the Internet.

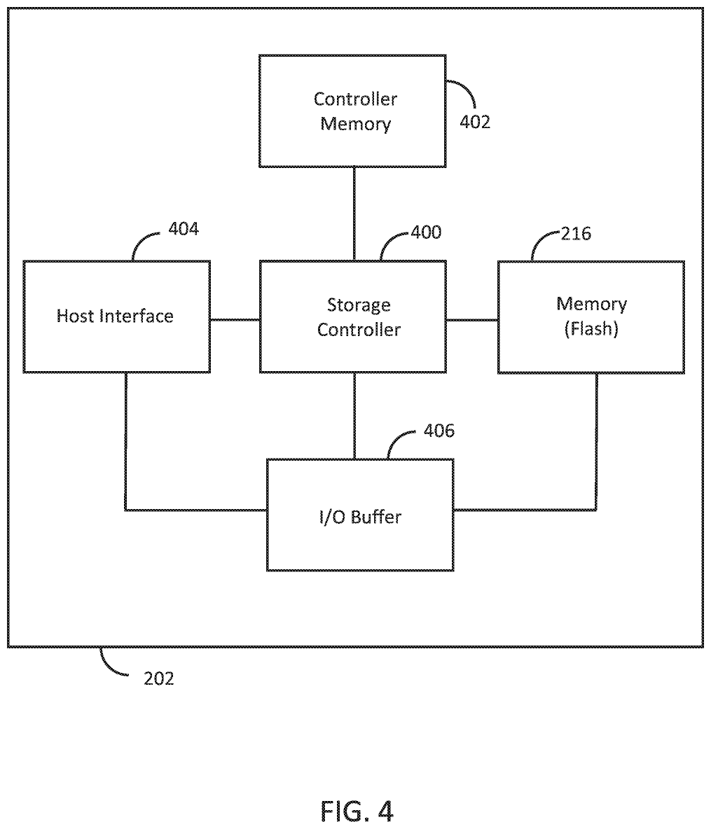

FIG. 3 is a functional block diagram of host processing system 204 and mass data storage device 206 as shown in FIG. 2. Host processing system 204 comprises host processor 300, host memory 302, user interface 304, buffer 306 and data storage interface 308. These components form the foundation for a number of different computing devices, such as personal computers, smart phones, servers, digital cameras, etc. used to perform a variety of applications such as word processing, web browsing, email delivery, digital photography, and many others. In many of these applications, data is stored and/or retrieved by host processor 300 from mass data storage device 206.

Host processor 300 is configured to provide general operation of host processing system 204 by executing processor-executable instructions stored in host memory 302, for example, executable computer code. Host processor 300 typically comprises a general purpose microprocessor or microcontroller manufactured by Intel Corporation of Santa Clara, Calif. or Advanced Micro Devices of Sunnyvale, Calif., selected based on computational speed, cost and other factors.

Host memory 302 comprises one or more non-transitory information storage devices, such as RAM, ROM, EEPROM, UVPROM, flash memory, SD memory, XD memory, or other type of electronic, optical, or mechanical memory device. Host memory 302 is used to store processor-executable instructions for operation of host processing system 204, including processor-executable instructions for processor 300, or some other processor within host processing system 204, to implement the functionality of filesystem wrapper 218. It should be understood that in some embodiments, a portion of host memory 302 may be embedded into host processor 300 and, further, that host memory 302 excludes media for propagating signals.

Buffer memory 306 is coupled to processor 300 and, typically, to data storage interface 308. Buffer memory 306 comprises a storage device for temporarily storing files to be stored to mass data storage device 206, or files retrieved from mass data storage device 206. Buffer memory 306 typically comprises one or more RAM memories, or by using a virtual data buffer defined in the processor-executable instructions stored in memory 302, pointing at a location in memory 302 or in buffer memory 306.

Data storage interface 308 is coupled to processor 302 and to communication bus 212, for sending and receiving commands and file data. Data storage interface comprises well-known circuitry for providing high speed data transfers between host processing system 204 and mass data storage device 206. Such circuitry utilizes one of a number of well-known high speed data protocols, such as SATA, SATEe, SAS, eMMC, UFS, PCI, PCIe, NVMe, PCI-X, USB, and others. Data storage interface 308 typically comprises data storage driver(s) 210, comprising executable instructions for receiving file store and file retrieve commands from filesystem wrapper 218, and for using the information in the commands from filesystem wrapper 218 to form commands suitable for mass data storage device 206, such as device or vendor-specific commands to store and retrieve data.

Mass data storage device 206 comprises one or more Solid State Drives (SSDs), magnetic hard drives, magnetic tape drives, or some other storage medium capable of storing relatively large amounts of data, such as more than 1 gigabyte. Mass data storage device 206 comprises filesystem 218, which may comprise processor-executable instructions stored in a memory, that performs management of storage space, maintaining data structures to organize file data and metadata, and read/write operations used during data storage and retrieval. More details regarding filesystem 218 is discussed later herein. In other embodiments, mass data storage device 206 could comprise a video card, a sound card, a digital camera or some other peripheral device.

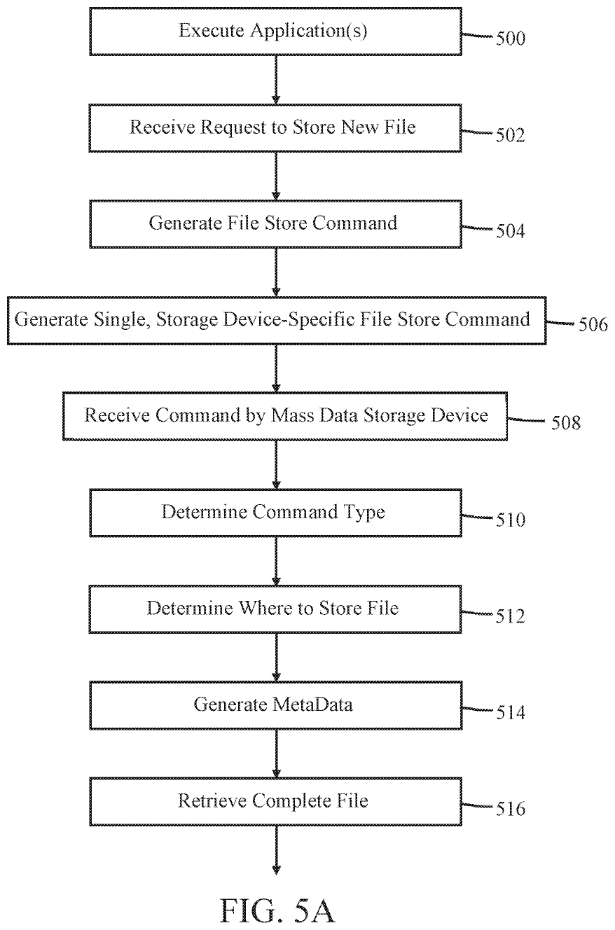

FIG. 4 is a simplified functional block diagram of one embodiment of mass data storage device 206. It should be understood that in other embodiments, the functions shown in FIG. 4 could be incorporated into a single ASIC or a System-on-a-Chip (SoC). Commands from host processing system 204 are received via host interface 404, such as “file retrieve” and “file store”. However, these commands are different than prior art commands, in that there is no address specified in mass data storage device 206 on where to open, close, read or write. The address information is determined by storage controller 400, as will be explained in greater detail later herein.

Host interface 404 comprises well-known circuitry for providing high speed data transfers between host processing system 204 and mass data storage device 206. Such circuitry utilizes one of a number of well-known high speed data protocols, such as SATA, SATEe, SAS, eMMC, UFS, PCI, PCIe, NVMe, PCI-X, USB, and others.

Controller 400 is configured to provide general operation of mass data storage device 206 by executing processor-executable instructions stored in processor memory 402, for example, executable computer code. Controller 400 is responsible for responding to open, close, read and write commands sent by host processing system 204. Controller 400 typically comprises one or more specialized microprocessors, microcontrollers, custom ASICS, and/or SoCs. Controller 400 is typically selected based on computational speed, cost, size and other considerations.

Processor memory 402 comprises one or more non-transitory information storage devices, such as RAM, ROM, EEPROM, flash memory, SD memory, XD memory, or other type of electronic, optical, or mechanical memory device. Processor memory 402 is used to store processor-executable instructions for operation of controller 400, including processor-executable instructions for controller 400, or some other processor within mass data storage device 206, to implement the functionality of filesystem 208. It should be understood that in some embodiments, processor memory 402 is incorporated into controller 400 and, further, that processor memory 402 excludes media for propagating signals.

Input/Output buffer 406 comprises one or more mass data storage devices for providing temporary storage for data to be stored in mass storage memory 216 and/or data that has been retrieved from mass storage memory 216 and awaiting transmission to host processing system 204. Buffer 406 typically comprises RAM memory for fast access to the data.

Mass storage memory 216 comprises one or more non-transitory information storage devices, such as RAM memory, flash memory, SD memory, XD memory, or other type of electronic, optical, or mechanical memory device, used to store data provided by host processing system 204. In one embodiment, mass storage memory 216 comprises a number of NAND flash memory chips, arranged in a series of banks and channels, to provide storage for up to multiple terabytes of data. Mass storage memory 216 is typically coupled to controller 400 via a number of data and control lines, and in some embodiments, a specialized interface is provided between controller 400 and mass storage memory 216 to aid in the storage and retrieval process. Mass storage memory 216 excludes media for propagating signals.

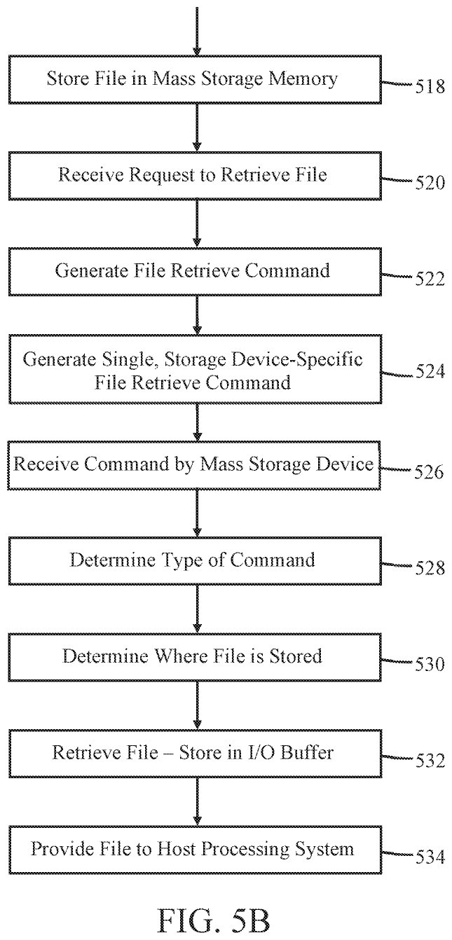

FIGS. 5A and 5B constitute a flow diagram illustrating one embodiment of a method, or algorithm, performed by storage and retrieval system 100. More specifically, the method describes interactions between host processing device 204 and mass data storage device 206 and, even more specifically, operations performed by host processor 300 and data storage controller 400, each executing processor-executable instructions stored in host memory 302 and mass data storage device memory 402, respectively. It should be understood that in some embodiments, not all of the steps shown in FIG. 5 are performed, and that the order in which the steps are carried out may be different in other embodiments. It should be further understood that some minor method steps have been omitted for purposes of clarity.

The method is described in two sections: blocks 500 through 516 describe how data storage and retrieval system 100 stores a new file. Blocks 518 through 532 describe how data storage and retrieval system 100 retrieves a file that has previously been stored on mass data storage device 206. Although only these two operations are described in detail in FIG. 5, it should be understood that other operations could also be performed.

At block 500, an application 202 is executed by host processing system 204 in response to a user operating host processing system 204. The application 202 may utilize files previously stored in mass data storage device 206, and/or it may create new files, or other information, such as in the case of a digital photography application running on a smart phone.

At block 502, application 202 generates a request to store a new file associated with application 202. Such information can include a digital spreadsheet, a digital text document, a digital photograph, a digital video, an email, or other information, such as large volumes of user data in the case where data storage and retrieval system 100 comprises a cloud-based, back-up storage system. Such information shall be referred to collectively herein as “files”.

The request to store information is typically generated in response to the user interaction with application 202. The request typically comprises a full path name, comprising a name of the file and a directory on mass data storage device 206 where the file should be stored, i.e., C:\documents\file.docx. The request is then provided to processor 300.

At block 504, the request is received by processor 300, where filesystem wrapper 218 is invoked. In response to the request, filesystem wrapper 218 generates a “file store” command, which causes mass data storage device 206 to allocate storage space on mass data storage device, followed by storage of the entire file to the storage space allocated by mass data storage device 206. Thus, storage of the entire file occurs with a single command. This is unlike prior art storage systems, where a file store command generated by a filesystem resident within host processing system 204 results in multiple read/write commands by the storage device drivers to allocate space on mass data storage device 106, followed by numerous read/write commands across communication bus 112 for storing the actual file data onto mass data storage device 106.

Filesystem wrapper 218 may additionally generate metadata associated with the file to be created, comprising information such as the size of the file, whether the file can be read/written/executed, an owner of the file, a time and date when the file was last created, accessed, or modified, and other information. In one embodiment, the create command causes mass data storage device 206 to assign a “file handle” to the file about to be stored. Host processor 300 may use the file handle in further operations concerning the particular file, such as future read and write operations.

The file store command may identify a device-specific, or “vendor-specific” command provided by storage device driver(s) 210, described below, or a standard command recognized by the mass data storage device to allow access to mass data storage device 206.

At block 506, data storage interface 208 receives the file store command, which the storage device driver(s) 210 identifies as a command for use with a vendor-specific or device-specific command to access mass data storage device 206. The vendor-specific command may be one of a set of commands available to filesystem wrapper 218 by storage device driver(s) 210. While many of the standard commands provided by storage device driver(s) 210 allow particular access to mass data storage device 206 in traditional ways, vendor-specific or device-specific commands are flexible in that they allow customized access to mass data storage device 206. The set of commands available to filesystem wrapper 218 may be determined using traditional methods, such as where processor 300 performs an initialization with mass data storage device 206 when mass data storage device 206 is first introduced into host processing system 204, during an initial power up of host processing system 204 with mass data storage device 206 included or, generally, when mass data storage device 206 is mounted.

As an example, in one embodiment, the file store command from filesystem wrapper 218 identifies a vendor-specific command offered by storage device driver(s) 210 based on the well-known NVMe data storage and retrieval protocol. NVMe is a storage interface specification for Solid State Drives (SSDs) on a PCIe bus. The latest version of the NVMe specification can be found at www.nvmexpress.org, presently version 1.3, dated May 1, 2017, and is incorporated by reference in its entirety herein. An example of a general vendor-specific command format in accordance with the NVMe protocol is shown below and referenced in the NVMe specification as FIG. 12.

### Command Format—Admin and NVM Vendor Specific Commands

| Bytes | Description |
|---|---|
| 03:00 | Command Dword 0 (CDW0): This field is common to all |
| | commands and is defined in FIG. 10. |
| 07:04 | Namespace Identifier (NSID): This field indicates the namespace |
| | ID that this command applies to. If the namespace ID is not used |
| | for the command, then this field shall be cleared to 0 h. Setting |
| | this value to FFFFFFFFh causes the command to be applied to all |
| | namespaces attached to this controller, unless otherwise |
| | specified. |
| | The behavior of a controller in response to an inactive namespace |
| | ID for a vendor specific command is vendor specific. Specifying |
| | an invalid namespace ID in a command that uses the namespace ID |
| | shall cause the controller to abort the command with status |
| | Invalid Namespace or Format, unless otherwise specified. |
| 15:08 | Reserved |
| 39:16 | Refer to FIG. 11 for the definition of these fields. |
| 43:40 | Number of Dwords in Data Transfer (NDT): This field indicates |
| | the number of Dwords in the data transfer. |
| 47:44 | Number of Dwords in Metadata Transfer (NDM): This field |
| | indicates the number of Dwords in the metadata transfer. |
| 51:48 | Command Dword 12 (CDW12): This field is command specific |
| | Dword 12. |
| 55:52 | Command Dword 13 (CDW13): This field is command specific |
| | Dword 13. |
| 59:56 | Command Dword 14 (CDW14): This field is command specific |
| | Dword 14. |
| 63:60 | Command Dword 15 (CDW15): This field is command specific |
| | Dword 15. |

In this embodiment, each vendor specific command consists of 16 Dwords, where each Dword is 4-bytes long (so, the command itself is 64-bytes long). The vendor-specific command comprises Command Dword 0, a Namespace Identifier field, a reserved field, an action identifier (i.e., “open”, “close”, “create”, “store”, “retrieve”) and, in some embodiments, a full path name of the file, a metadata pointer (i.e., where in host memory 302 the metadata is stored), a Data pointer (i.e., wherein in host memory 302 the actual file data is stored), a Number of Dwords in Data Transfer field, a Number of Dwords in Metadata Transfer field, and 4 command Dwords. It should be understood that in other embodiments, a different arrangement of the fields and the number of bits per field could be different than what is described in this embodiment.

When storage device driver(s) 210 identify the file store command as invoking the vendor-specific command, storage device driver(s) 210 generates the vendor specific command by mapping data from the file store command into the vendor-specific command. In this embodiment, an identifier bytes 16-39 are used to place the word “store”, “file store”, or some other reference to file storage, and, in one embodiment, identify a full path name identifying the name of the file to be stored as well as its directory, as a payload. The last four Dwords, i.e., bytes 48-63, are used to place some or all of the metadata associated with the file, such as a full path name of the file, the file size, permissions, etc. Buffer memory within host processing system 204 may also be identified in one of the vendor-specific fields, such as memory 302 or a buffer memory (not shown), and one or more addresses or offsets may be provided, identifying where the file to be written is stored in host processing system 204. Once the vendor-specific command has been generated, it is provided to mass data storage device 206 via communication bus 212. It should be understood that the vendor-specific command is the only command needed for storing the entire file to mass data storage device 206.

At block 508, host interface 404 in mass data storage device 206 receives the vendor-specific command, and provides it to controller 400.

At block 510, controller 400 determines that the vendor-specific command comprises a “file store” command, and in response, provides the information in the vendor-specific command to filesystem 208.

At block 512, filesystem 208 determines one or more locations in mass storage memory 216 where the file will be stored. In one embodiment, filesystem 208 determines where the file will be stored by performing a number of read and write operations to/from mass storage memory 216, memory 402 or some other memory associated with filesystem 208 (i.e., “local memory”), to allocate blocks of mass storage memory 216 to the file. This is accomplished by filesystem 208 accessing a data bitmap, an inode bitmap and one or more inode tables associated with mass storage memory 216, as is well-known in the art, and as shown below:

| | data | inode | root | foo | bar | root | foo | bar | bar | bar |
|---|---|---|---|---|---|---|---|---|---|---|
| | bitmap | bitmap | inode | inode | inode | data | data | data[0] | data[1] | data[2] |
| create | | | read | | | | | | | |
| (/foo/bar) | | | | | | read | | | | |
| | | | | read | | | | | | |
| | | | | | | | read | | | |
| | | read | | | | | | | | |
| | | write | | | | | | | | |
| | | | | | | | write | | | |
| | | | | | read | | | | | |
| | | | | | write | | | | | |
| | | | | write | | | | | | |
| write( ) | | | | | read | | | | | |
| | read | | | | | | | | | |
| | write | | | | | | | | | |
| | | | | | | | | write | | |
| | | | | | write | | | | | |
| write( ) | | | | | read | | | | | |
| | read | | | | | | | | | |
| | write | | | | | | | | | |
| | | | | | | | | | write | |
| | | | | | write | | | | | |
| write( ) | | | | | read | | | | | |
| | read | | | | | | | | | |
| | write | | | | | | | | | |
| | | | | | | | | | | write |
| | | | | | write | | | | | |

### File Creation Timeline (Time Increasing Downward)

The above table is taken from the book “Operating Systems: Three Easy Pieces”, by Remzi Arpaci-Dusseau & Andrea Arpaci-Dusseau, available at http://pages.cs.wisc.edu/˜remzi/OSTEP/ and incorporated by reference herein. Although the table references read and write operations performed by prior art storage and retrieval systems, i.e., where filesystem 208 located within host processing system 104, it is applicable to show how filesystem 208 in mass data storage device 206 interacts with a local memory to allocate storage space for a file. The table illustrates the various read and write operations performed by filesystem 208 to create a file named “bar” in a directory named “foo”. Filesystem 208 must not only allocate an inode, but also allocate space within the directory containing the new file. The amount of traffic required to do so is quite high: one read to the inode bitmap (to find a free inode), one write to the inode bitmap (to mark it allocated), one write to the new inode itself (to initialize it), one to the data of the directory (to link the high-level name of the file to its inode number), and one read and write to the directory inode to update it. If the directory needs to grow to accommodate the new entry, additional I/Os (i.e., to the data bitmap, and the new directory block) will be needed also. In the example where the file “bar” is created in the directory “foo”, reads and writes to local memory are grouped under which command caused them to occur, and the rough ordering they might take place, from top to bottom. 10 I/Os must take place in this example to allocate storage space within mass storage memory 216. Then, each time a block of data of the file is written, 5 I/Os occurs: a pair to read and update the inode, another pair to read and update the data bitmap, and then finally the write of the data itself. These I/Os would normally be transmitted over communication bus 112. However, all of the I/Os in the present embodiment occur onboard storage device 206, between filesystem 208 and a local memory where the inode tables and bitmap data are stored.

At block 514, filesystem 208 may generate metadata associated with the file. In this embodiment, filesystem may determine the size of the file, a time and date when the file was first created, stored, accessed, or modified, and other information that may be associated with the file. Filesystem updates the assigned inode with this metadata.

At block 516, after storage space for the file has been allocated in mass storage memory 216, controller 400 causes host interface 404 to retrieve the entire file data from memory 302, or a buffer memory as part of host processing system 204, over communication bus 212. The address and size of the file is known from information contained within the vendor-specific command that was received by host interface 404 at block 508. The entire file may be retrieved by simply reading buffer memory 306 over communication bus 212, without having to partition the data into blocks. The entire file is typically stored in I/O buffer 406. After retrieval, filesystem 208 may determine a size of the entire file, and allocate space in mass storage memory 216 in accordance with the file size, by updating metadata in the inode table corresponding to the file.

At block 518, filesystem 208 stores the entire file in mass storage memory 216 as it retrieves the file from I/O buffer 406. In one embodiment, filesystem 208 partitions the entire file into blocks, and stored the blocks in mass storage memory 216. In one embodiment, the metadata in the file's inode table is then updated to indicate where the blocks are stored.

At block 520, application 202 issues a “file retrieve” command to filesystem wrapper 218, for example, so that the user may read a text document or view a digital photograph or video. The retrieve command may comprise a full path name where the desired file is located.

At block 522, filesystem wrapper 218 generates a retrieve command comprising the full path name, and/or a file handle identifying the file. The retrieve command may identify a generic the same “vendor-specific” command used to write a file, as described above. The retrieve command is provided to data storage interface 208.

At block 524, data storage interface 208 receives the file retrieve command, which the storage device driver(s) 210 identifies as a command for use with the vendor-specific command. In response, the storage device driver(s) 210 forms a single, vendor-specific command by mapping data from the retrieve command into the vendor-specific command. In this embodiment, identifier bytes 16-39 are used to place the word “retrieve”, or some other reference to file retrieval, and, in one embodiment, identify a full path name identifying the name of the file to be stored as well as its directory, as a payload. The last four Dwords, i.e., bytes 48-63, are used to place some or all of the metadata associated with the file, such as a full path name of the file, the file size, permissions, etc. A memory within host processing system 204 may also be identified in one of the vendor-specific fields, such as memory 302 or a buffer memory (not shown), and one or more addresses or offsets may be provided, identifying where the file should be stored in host processing system 204 once it is retrieved by mass data storage device 206. Once the vendor-specific command has been generated, it is provided to mass data storage device 206 via communication bus 212. It should be understood that the vendor-specific command is the only command needed for retrieving the entire file from mass data storage device 206.

At block 526, host interface 404 in mass data storage device 206 receives the vendor-specific command, and provides it to controller 400.

At block 528, controller 400 determines that the vendor-specific command comprises a “retrieve” command, and in response, provides the information in the vendor-specific command to filesystem 208.

At block 530, filesystem 208 determines one or more locations in mass storage memory 216 where the file is stored. In one embodiment, filesystem 208 determines where the file is stored by performing a number of read and write operations to/from mass storage memory 216, memory 402 or some other memory associated with filesystem 208 (i.e., “local memory”). In one embodiment, filesystem 208 first finds an inode for the file specified in the vendor-specific command, to obtain some basic information about the file (permissions information, file size, etc.). Filesystem 208 first performs a read operation in a root directory of mass storage memory 216, generally referred to as /, to read the inode of the root directory, which is predefined and stored in local memory. For example, in most UNIX file systems, a root inode number is defined as 2. Thus, filesystem 208 reads a block of memory that contains inode number 2. Once the inode is read, filesystem 208 evaluates the data inside it to find one or more pointers to data blocks, which contain the contents of the root directory. Filesystem 208 will thus use these pointers to read through the directory, in this case looking for an entry for the directory specified in the vendor-specific command.

When filesystem 208 finds the entry for the directory; filesystem 208 retrieves the inode number of the directory (i.e., 44) which it will need next.

Filesystem 208 then recursively traverses the path name until the desired inode is found. In this example, filesystem 208 reads the block containing the inode of the directory and then its directory data, finally finding the inode number of the file.

Next, filesystem 208 reads the file's inode, wherein the file is considered to be “open”. The file's inode comprises metadata associated with the file, comprising a size of the file (sometimes expressed in a number of blocks), whether the file can be read/written/executed, an owner of the file, a time and date when the file was last created, accessed, or modified, and other information. The inode additionally comprises a starting address in mass storage memory 216 where the file is stored.

Next, filesystem 208 begins reading each block of the file as indicated by the inode, followed by a read of the next block, and so on until the entire file is read from mass storage memory 216.

At block 532, in one embodiment as the blocks are being read from mass storage memory 216, filesystem 208 provides the blocks to I/O buffer 406 for temporary storage.

At block 534, processor 300 causes host interface 404 to retrieve the blocks from I/O buffer 406, and provide them to host processing system 204 via communication bus 212, storing them in a buffer within host processing system 204 as directed by the vendor-specific command.

The methods or algorithms described in connection with the embodiments disclosed herein may be embodied directly in hardware or embodied in processor-readable instructions executed by a processor. The processor-readable instructions may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components.

Accordingly, an embodiment of the invention may comprise a computer-readable media embodying code or processor-readable instructions to implement the teachings, methods, processes, algorithms, steps and/or functions disclosed herein.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

I claim:

1. A mass data storage device, comprising:
host interface circuitry for receiving commands from a host processing system coupled to the mass data storage device via a communication bus, and for providing previously-stored file data to the host processing system via the communication bus;
a memory for storing processor-executable instructions:
a mass storage memory for storing data provided by the host processing system and for storing metadata associated with files stored on the mass storage memory; and
a storage controller, coupled to the host interface circuitry, the memory, and the mass storage memory, for executing the processor-executable instructions that causes the mass data storage device to:
receive a single command to store or retrieve an entire file by the host interface circuitry from the host processing system over the communication bus, the command comprising a file identifier;
determine, an address in the mass storage memory where to locate the file, based on the file identifier and the metadata; and
access a memory address in the mass storage memory in accordance with the metadata.

2. The mass data storage device of claim 1, wherein the single command comprises a single vendor-specific command comprising a payload indicative of a file retrieve command, and the processor-executable instructions that causes the mass data storage device to access the address in the mass storage memory comprises instructions that cause the mass data storage device to:
identify a starting address of the file associated with the file identifier in accordance with the metadata;
determine a number of data storage blocks associated with the file stored in the mass storage memory beginning at the starting address, the data storage blocks comprising at least a portion of the file;
retrieve the data storage blocks, by the processor, from the mass storage memory in accordance with the starting address and the number of data storage blocks associated with the file; and
provide the data storage blocks to the host interface device for transmission of the entire file to the host processing system over the standardized communication bus.

3. The mass data storage device of claim 2, wherein the instructions that cause the mass data storage device to retrieve the data storage blocks comprises instructions that cause the mass data storage device to:
retrieve all of the data storage blocks associated with the file without processing a write command from the host processing system over the standardized communication bus.

4. The mass data storage device of claim 3, wherein the file retrieve command comprises a standard command recognized by the mass data storage device, and the standard command comprises a payload;
wherein the payload comprises the retrieve command; and
the file retrieve command comprises an identification in a host data buffer where the data storage blocks are sent by the host interface circuitry.

5. The mass data storage device of claim 1, wherein the command comprises a file store command, and the processor-executable instructions that causes the mass data storage device to access the address in the mass storage memory comprises instructions that cause the mass data storage device to:
determine, by the filesystem module, a starting address for the file in the mass storage memory;
update the metadata to account for the file;
receive the entire file from the host processing system over the communication bus;
write the entire file to the mass storage memory, beginning at the starting address.

6. The mass data storage device of claim 5, wherein the instructions that cause the mass data storage device to write the entire file comprises instructions that cause the mass data storage device to:
write the entire file to the mass data storage device without processing a read command from the host processing system over the standardized communication bus.

7. The mass data storage device of claim 1, wherein the command comprises a standard command recognized by the mass data storage device, the standard command comprises a payload;
wherein the payload comprises a file store command; and
the file store command comprises an identification in a host data buffer where the data storage blocks are stored by the host interface circuitry over the communication bus.

8. The mass data storage device of claim 1, the processor-executable instructions further comprise instructions that causes the mass data storage device to:
generate a file handle in response to receiving the command, the file handle used to temporarily identify the file;
provide the file handle to the host interface circuitry for use by the host processing system to identify the file in a subsequent file store or file retrieve operation.

9. A method, performed by a mass data storage device coupled to a host processing system via a communication bus, for efficient data storage and retrieval, comprising:
receiving a single command to store or retrieve an entire file by the host interface circuitry from the host processing system over the communication bus, the command comprising a file identifier;
determining an address in a mass storage memory within the mass data storage device where to find the file, based on the file identifier and the metadata stored by a memory within the mass data storage device; and
accessing a memory address, by the filesystem, in the mass storage memory in accordance with the metadata.

10. The method of claim 9, wherein the single command comprises single, a vendor-specific command comprising a payload indicative of a file retrieve command, and accessing the address in the mass storage memory comprises:
identifying a starting address of the file associated with the file identifier in accordance with the metadata;
determining a number of data storage blocks associated with the file stored in the mass storage memory beginning at the starting address, the data storage blocks comprising at least a portion of the file;
retrieving the data storage blocks, by the processor, from the mass storage memory in accordance with the starting address and the number of data storage blocks associated with the file; and
providing the data storage blocks to the host interface device for transmission of the entire file to the host processing system over the standardized communication bus.

11. The method of claim 9, wherein the instructions that cause the mass data storage device to retrieve the data storage blocks comprises instructions that cause the mass data storage device to:
retrieve all of the data storage blocks associated with the file without processing a write command from the host processing system over the standardized communication bus.

12. The method of claim 11, wherein the file retrieve command comprises a standard command recognized by the mass data storage device, and the standard command comprises a payload;
wherein the payload comprises the retrieve command; and
the file retrieve command comprises an identification in a host data buffer where the data storage blocks are sent by the host interface circuitry.

13. The method of claim 9, wherein the command comprises a file store command, and the processor-executable instructions that causes the mass data storage device to access the address in the mass storage memory comprises instructions that cause the mass data storage device to:
determine, by the filesystem module, a starting address for the file in the mass storage memory;
update the metadata to account for the file;
receive the entire file from the host processing system over the communication bus;
write the entire file to the mass storage memory, beginning at the starting address.

14. The method of claim 13, wherein the instructions that cause the mass data storage device to write the entire file comprises instructions that cause the mass data storage device to:
write the entire file to the mass storage device without processing a read command from the host processing system over the standardized communication bus.

15. The method of claim 9, wherein the command comprises a standard command recognized by the mass data storage device, the standard command comprises a payload;
wherein the payload comprises a file store command; and
the file store command comprises an identification in a host data buffer where the data storage blocks are stored by the host interface circuitry over the communication bus.

16. The method of claim 9, the processor-executable instructions further comprise instructions that causes the mass data storage device to:
generate a file handle in response to receiving the command, the file handle used to temporarily identify the file;
provide the file handle to the host interface circuitry for use by the host processing system to identify the file in a subsequent file store or file retrieve operation.

17. A host processing system for efficient data storage and retrieval, comprising:
a host processing system, comprising:
a host memory for storing processor-executable instructions;
a filesystem wrapper for providing a file storage and retrieval operation for an application running on the host processing system;
a storage device driver for communication with the host processing system over a communication bus; and
a processor coupled to the host memory, the filesystem wrapper, and the storage device driver for executing the processor-executable instructions that cause the host processing device to;
receive a request from an application running on the host processing system to store or retrieve a file from a mass storage device coupled to the host processing system via a communication bus:
encapsulate a file identifier associated with the file;
provide the encapsulated file identifier as a single request to the storage device driver; and
receive the entire file in response to sending the single request.
